(19) United States
(12) Patent Application Publication
(10) Pub. No.: US 2013/0278423 A1
(43) Pub. Date: Oct. 24, 2013

(54) DETECTING DEVICE AND OPERATING METHOD THEREOF

(71) Applicant: LIVINGSTYLE ENTERPRISES LIMITED, Dong Guan City (CN)

(72) Inventors: MING-YUN CHEN, Dong Guan City (CN); SHENG-GUO HONG, Dong Guan City (CN)

(73) Assignee: LivingStyle Enterprises Limited, Dong Guan City (CN)

(21) Appl. No.: 13/864,405

(22) Filed: Apr. 17, 2013

(30) Foreign Application Priority Data
Apr. 20, 2012 (CN) 201210118585.8

(51) Int. Cl. G01V 8/20; H05B 37/02

(52) U.S. Cl. CPC G01V 8/20; H05B 37/0227
USPC 340/556; 250/349; 250/338.4; 250/341.8; 315/154; 348/164

(57) ABSTRACT

A detecting device includes at least one transmitter and plural receivers. After the at least one transmitter emits plural incident light beams to a detection zone, plural reflected light beams reflected from the detection zone are received by the plural receivers. If no object is moved within the detection zone, the plural reflected light beams strike a first part of the plural receivers, so that the plural receivers are in an initial reception configuration. If an object is moved within the detection zone, the plural reflected light beams are disturbed by the object and deflected to a second part of the plural receivers, so that the plural receivers are in a disturbed reception configuration. According to the reception configuration change, a moving direction of the object within the detection zone is determined. Consequently, the detecting range is largely enhanced, and the cost is reduced.

### FIELD OF THE INVENTION

The present invention relates to a detecting device, and more particularly to a detecting device for performing ambient detection by using an active infrared detecting technology. The present invention also relates to an operating method of the detecting device.

### BACKGROUND OF THE INVENTION

Nowadays, an active infrared detecting technology is used for detecting an object by arranging a transmitter and a receiver of a detecting device along a line. Moreover, the transmitter and the receiver are cooperated in a one-to-one manner. That is, the transmitter continuously emits a light beam, and the receiver continuously receives the light beam. A method of performing the active infrared detecting technology will be illustrated as follows. For example, if the optical path of the light beam is interrupted, the detecting device may judge that an object enters a detection zone. Afterwards, a corresponding action is performed. For example, a lighting device is turned on, an alarm is enabled to generate a warning sound, or an image pickup device is enabled to record images.

Conventionally, the use of the active infrared detecting technology is only able to turn on or turn off a corresponding electrical appliance. For example, if the light beam is interrupted, an image pickup device may be turned on. However, since the image pickup device fails to be moved along the moving direction of the object, the image pickup device cannot record the image of the object by tracking the moving object. In other words, the current detecting method is very simple and passive. Moreover, since the transmitter and the receiver are distributed in a line (i.e. in a one dimensional arrangement), the detecting range of the conventional detecting device is very narrow. For increasing the detecting range, it is necessary to install many transmitters and many receivers. Under this circumstance, the cost is increased.

Therefore, there is a need of providing a detecting device with a wide detecting range and reduced cost. Moreover, there is a need of providing a detecting device for enabling an ambient electrical appliance (e.g. a lighting device or an image pickup device) to perform a corresponding action in response to the movement of the object by detecting the moving direction of the object.

### SUMMARY OF THE INVENTION

For overcoming the drawbacks encountered from the prior art, the present invention provides a detecting device and an operating method of the detecting device by utilizing an active infrared detecting technology to detect a large area.

For overcoming the drawbacks encountered from the prior art, the present invention also provides a detecting device and an operating method of the detecting device for detecting a moving direction of an object. Moreover, an ambient electrical appliance is electrically connected with the detecting device. By tracking the moving object, an ambient electrical appliance of the detecting device can perform a corresponding action such as the action of turning on a lighting device, emitting a sound or recording an image.

In accordance with an aspect of the present invention, there is provided a detecting device for detecting a detection zone. The detecting device includes at least one transmitter and plural receivers. The at least one transmitter is used for emitting plural incident light beams to the detection zone. The plural receivers are used for receiving plural reflected light beams which are reflected from the detection zone in response to the plural incident light beams. When the at least one transmitter emits the plural incident light beams to the detection zone at a first time spot, the plural reflected light beams strike a first part of the plural receivers, so that the plural receivers are in an initial reception configuration. When the at least one transmitter emits the plural incident light beams to the detection zone at a second time spot, if an object is moved within the detection zone, the plural reflected light beams strike a second part of the plural receivers in response to a position change of the object, so that the plural receivers are in a disturbed reception configuration. According to the disturbed reception configuration, the detecting device judges that the object is moved within the detection zone.

In an embodiment, the detecting device further includes a microprocessor. The microprocessor is electrically connected with the plural receivers. A moving direction of the object is calculated by the microprocessor according to projecting areas and/or angles of the reflected light beams relative to the first part and the second part of the plural receivers.

In an embodiment, the transmitter is an active infrared transmitter.

In an embodiment, each of the plural receivers is selected from an active infrared receiver, a charge coupled device with an infrared filter or a complementary metal-oxide-semiconductor with an infrared filter.

In an embodiment, the detecting device further includes an image pickup device, which is electrically connected with the plural receivers. When the plural receivers are in the disturbed reception configuration, the plural receivers issue a signal to the image pickup device, thereby enabling the image pickup device.

In an embodiment, the image pickup device is moved along the moving direction of the object for recording an image of the object. By analyzing and judging a distance between the object and the image pickup device, the microprocessor allows the image pickup device to be focused on the object.

In an embodiment, the detecting device further includes at least one lighting device, which is electrically connected with the plural receivers. When the plural receivers are in the disturbed reception configuration, the plural receivers issue a signal to the at least one lighting device, thereby enabling the at least one lighting device.

In an embodiment, the lighting device is a light bulb, a light tube, a lamp or a work light. The lamp is a ceiling lamp or a garden lamp, and the work light is a work light with a spraying function or a work light with a humidifying function.

In an embodiment, the detecting device further includes a lighting group. The lighting group includes at least one first lighting device and a second lighting device. The at least one first lighting device and the second lighting device are in communication with each other through a communication channel.

In an embodiment, the first lighting device is a master control lighting device, and the second lighting device has a controlled function. According to a result of detecting the detection zone, the first lighting device is actively controlled to be turned on or turned off, and the second lighting device is passively controlled to be turned on or turned off in response to a control command from the first lighting device.

In an embodiment, each of the first lighting device and the second lighting device has both of a master control function and a controlled function. When a lighting control program is executed, the first lighting device and the second lighting device are controlled to be turned on or turned off.

In an embodiment, the detecting device further includes an alarm, which is electrically connected with the plural receivers. When the plural receivers are in the disturbed reception configuration, the plural receivers issue a signal to the alarm, thereby enabling the alarm.

In an embodiment, the plural receivers are distributed in an array arrangement or a linear arrangement.

In accordance with another aspect of the present invention, there is provided an operating method of a detecting device. Firstly, at least one transmitter emits plural incident light beams to the detection zone at a first time spot, and plural receivers receive plural reflected light beams which are reflected from the detection zone in response to the plural incident light beams. The plural reflected light beams strike a first part of the plural receivers, so that the plural receivers are in an initial reception configuration. Then, the at least one transmitter emits the plural incident light beams to the detection zone at a second time spot, and the plural receivers to receive the plural reflected light beams which are reflected from the detection zone in response to the plural incident light beams. If an object is moved within the detection zone, the plural reflected light beams are disturbed by the object and deflected to a second part of the plural receivers, so that the plural receivers are in a disturbed reception configuration. If no object is moved within the detection zone, the plural reflected light beams still strike the first part of the plural receivers, so that the plural receivers are in the initial reception configuration. Afterwards, a spatial status of the detection zone is determined according to a reception configuration change between the first time spot and the second time spot.

In an embodiment, the detecting device further includes a microprocessor, which is electrically connected with the plural receivers. A moving direction is calculated by the microprocessor according to projecting areas and/or angles of the reflected light beams relative to the first part and the second part of the plural receivers.

In an embodiment, the transmitter is an active infrared transmitter.

In an embodiment, each of the plural receivers is selected from an active infrared receiver, a charge coupled device with an infrared filter or a complementary metal-oxide-semiconductor with an infrared filter.

From the above descriptions, the present invention provides a detecting device with at least one transmitter and plural receivers. After the at least one transmitter emits plural incident light beams to a detection zone, plural reflected light beams reflected from the detection zone are received by the plural receivers. Moreover, if the spatial status of the detection zone is changed, the reflected light beams are received by the plural receivers in various reception configurations. In other words, the current one dimensional detecting mechanism is improved as the three dimensional detecting mechanism of the present invention. Consequently, the detectable range is largely increased, and therefore the total number of the at least one transmitter and the plural receivers is reduced, so that the cost is reduced. Moreover, after the reception configuration of the receivers is received by the microprocessor, the moving direction and the displacement of the object can be realized. Consequently, the ambient electrical appliance of the detecting device can perform a corresponding action by tracking the movement of the object.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a detecting device according to an embodiment of the present invention, in which plural incident light beams from a transmitter strike a first sub-zone and plural reflected light beams from the first sub-zone are received by a first part of plural receivers;

FIG. 2 schematically illustrates the detecting device according to the embodiment of the present invention, in which plural incident light beams from the transmitter strike a second sub-zone and plural reflected light beams from the second sub-zone are received by the first part of plural receivers;

FIG. 3 schematically illustrates the detecting device according to the embodiment of the present invention, in which plural incident light beams from the transmitter strike an object and the reflected light beams from the object are received by a second part of the plural receivers.

FIG. 4 schematically illustrates the detecting device according to the embodiment of the present invention, in which plural incident light beams from the transmitter strike the detection zone and the reflected light beams from the detection zone are received by the second part of the plural receivers;

FIG. 5 schematically illustrates an implementation example of the detecting device according to the embodiment of the present invention, in which the detecting device further comprises an image pickup device;

FIG. 6 schematically illustrates an implementation example of the detecting device according to the embodiment of the present invention, in which the detecting device further comprises at least one lighting device;

FIG. 7 schematically illustrates a first example of a group control mechanism of the detecting device according to the embodiment of the present invention;

FIG. 8 schematically illustrates a second example of a group control mechanism of the detecting device according to the embodiment of the present invention; and

FIG. 9 is a flowchart illustrating an operating method of the detecting device according to an embodiment of the present invention.

### DETAILED DESCRIPTION OF THE PREFERRED EMBODIMENT

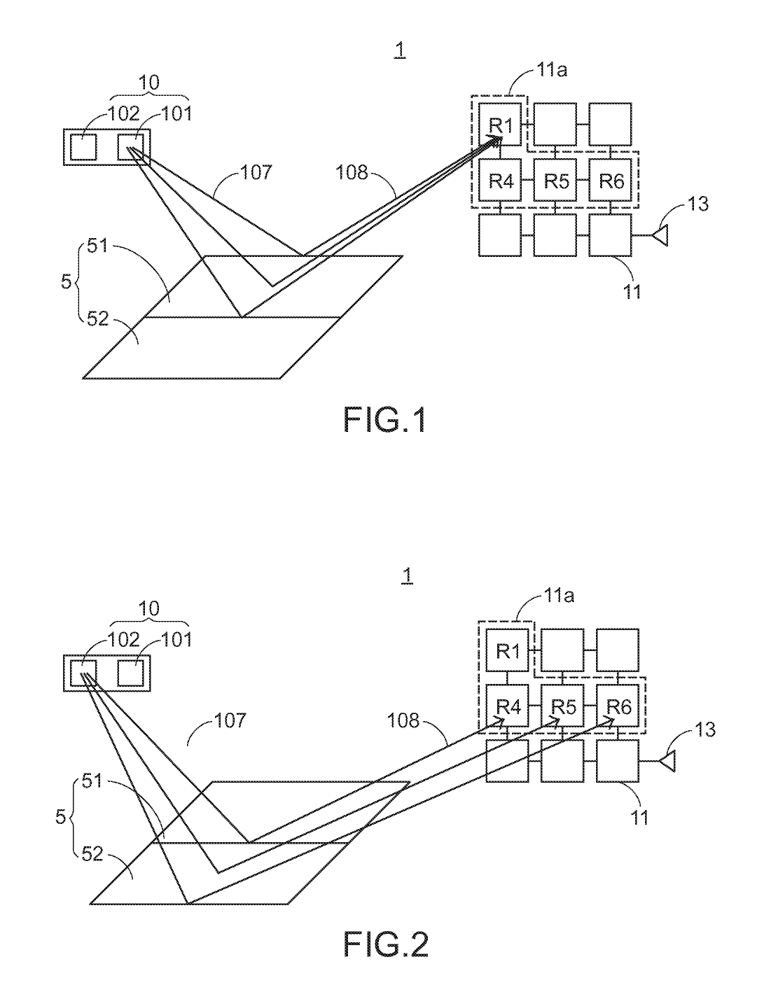

FIG. 1 schematically illustrates a detecting device according to an embodiment of the present invention, in which plural incident light beams from a transmitter strike a first sub-zone and plural reflected light beams from the first sub-zone are received by a first part of plural receivers. FIG. 2 schematically illustrates the detecting device according to the embodiment of the present invention, in which plural incident light beams from the transmitter strike a second sub-zone and plural reflected light beams from the second sub-zone are received by the first part of plural receivers.

In FIGS. 1 and 2, a detection zone 5 is irradiated by at least one transmitter 10 at the same time spots. For clearly understanding the relationships between the incident light beam 107, the reflected light beam 108 and plural receivers 11, the detection zone 5 is divided into plural sub-zones and the optical paths associated with respective sub-zones are separately shown in different drawings.

The number of the sub-zone of the detection zone 5, the number of the at least one transmitter 10 and the number of the plural receivers 11 may be determined by the manufacturer according to the practical requirements. For example, the detecting device 1 may comprise one transmitter 10 and one receiver 11, or comprise one transmitter 10 and two receivers 11, or comprise one transmitter 10 and four receivers 11, or comprise two transmitters 10 and two receivers 11, or comprise two transmitters 10 and four receivers 11. Hereinafter, the present invention will be illustrated by referring to the detecting device 1 with two transmitters 101, 102 and nine receivers 11. Moreover, the detection zone 5 is divided into two sub-zones 51 and 52. It is noted that the numbers of the transmitters and the receivers may be varied according to the practical requirements. Moreover, the plural receivers 11 may be distributed in an array arrangement or a linear arrangement, and the arrangement of the receivers 11 is not limited thereto.

As shown in FIG. 1, when plural incident light beams 107 emitted by the transmitter 101 are directed to the first sub-zone 51 of the detection zone 5 at a first time spot, plural reflected light beams 108 from the first sub-zone 51 are received by the receiver R1 of the nine receivers 11. As shown in FIG. 2, when plural incident light beams 107 emitted by the transmitter 102 are directed to the second sub-zone 52 of the detection zone 5 at the first time spot, plural reflected light beams 108 from the second sub-zone 52 are received by the three receivers R4, R5 and R6 of the nine receivers 11. Consequently, after the first sub-zone 51 and the second sub-zone 52 are respectively irradiated by the transmitters 101 and 102, different reflected light beams 108 are received by the receivers 11 in different reception configurations. In accordance with this feature, the detecting device 1 is capable of identifying the spatial status of the detection zone 5 by emitting the incident light beams 107 to an object within the detection zone 5. As shown in FIGS. 1 and 2, after the first sub-zone 51 and the second sub-zone 52 are respectively irradiated by the transmitters 101 and 102, the plural reflected light beams 108 are received by a first part 11a of the receivers 11 including the receivers R1, R4, R5 and R6. Under this circumstance, the receivers 11 are in an initial reception configuration.

Then, the incident light beams 107 are continuously emitted by the transmitters 10, and thus the reflected light beams 108 are continuously received by the receivers 11. Alternatively, the incident light beams 107 are periodically emitted by the transmitters 10 every a preset time interval (e.g. every 1 millisecond), and the reflected light beams 108 are periodically received by the receivers 11 every the preset time interval. Consequently, as long as no object is moved within the detection zone 5, the reflected light beams 108 are continuously or periodically received by the first part 11a of the receivers 11. Under this circumstance, the receivers 11 are maintained in the initial reception configuration.

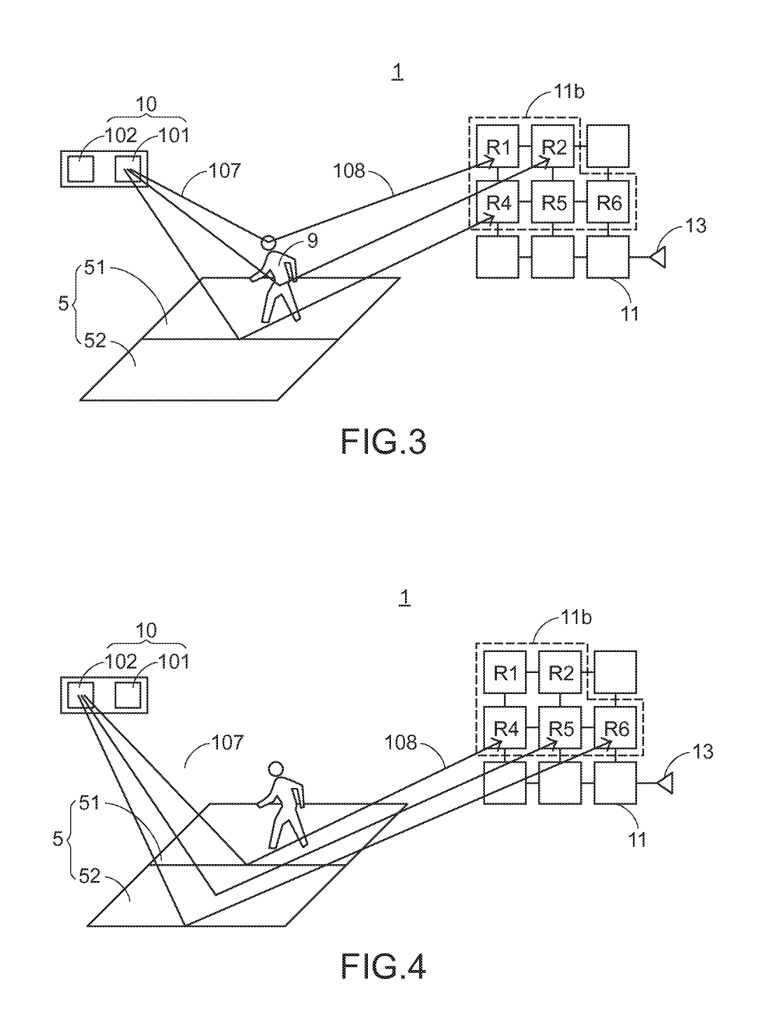

FIG. 3 schematically illustrates the detecting device according to the embodiment of the present invention, in which plural incident light beams from the transmitter strike an object and the reflected light beams from the object are received by a second part of the plural receivers. FIG. 4 schematically illustrates the detecting device according to the embodiment of the present invention, in which plural incident light beams from the transmitter strike the detection zone and the reflected light beams from the detection zone are received by the second part of the plural receivers. Regardless of whether the object 9 is introduced from the surroundings to the detection zone 5 or the object 9 is originally present in the detection zone 5, if the object 9 is moved within the detection zone 5, the position of the object 9 is changed. As the position of the object 9 is changed, the optical paths of the reflected light beams 108 in response to the incident light beams 107 will be deflected. Consequently, the reflected light beams 108 strike a different part of the plural receivers 11.

As shown in FIG. 3, the object 9 is moved within the first sub-zone 51 at a second time spot. The plural incident light beams 107 from the transmitter 101 are still directed to the first sub-zone 51. However, since the plural incident light beams 107 are disturbed by the object 9, the original reflected light beams 108 are deflected. Under this circumstance, the optical paths of the reflected light beams 108 are changed, and thus the reflected light beams 108 are received by the three receivers R1, R2 and R4 of the nine receivers 11. As shown in FIG. 4, the plural incident light beams 107 from the transmitter 102 are directed to the second sub-zone 52 at the second time spot. Since the plural incident light beams 107 are not disturbed by the object 9, the plural reflected light beams 108 are still received by the three receivers R4, R5 and R6 of the nine receivers 11. As shown in FIGS. 3 and 4, when the first sub-zone 51 and the second sub-zone 52 are respectively irradiated by the transmitters 101 and 102 at the second time spot, the plural reflected light beams 108 are received by a second part 11b of the receivers 11 including the receivers R1, R2, R4, R5 and R6. Under this circumstance, the receivers 11 are in a disturbed reception configuration. In other words, if the reception configuration of the receivers 11 is switched from the initial reception configuration to the disturbed reception configuration, the detecting device 1 realizes that the object 9 is moved within the detection zone 5.

Please refer to FIGS. 1˜4 again. The detecting device 1 further comprises a microprocessor 13. The microprocessor 13 is electrically connected with the plural receivers 11. If the reflected light beams 108 at the first time spot and the reflected light beams 108 at the second time spot are received by different parts of the plural receivers 11, the reception configuration of the plural receivers 11 at the first time spot (i.e. the first part 11a of the plural receivers 11) and the reception configuration of the plural receivers 11 at the second time spot (i.e. the second part 11b of the plural receivers 11) are different. By comparing the reception configuration at the second time spot with the reception configuration at the second time spot, the microprocessor 13 judges that the object 9 is moved within the detection zone 5. Moreover, the projecting areas and/or the angles of the reflected light beams 108 relative to the first part 11a and the second part 11b of the plural receivers 11 are acquired by the microprocessor 13. After the time parameters are added and a computation is performed, a moving direction and a displacement of the object 9 can be calculated.

Moreover, in a preferred embodiment, the transmitter 10 of the detecting device 1 is selected from an active infrared transmitter, and the receiver 11 of the detecting device 1 is an active infrared receiver, a charge coupled device (CCD) with an infrared filter or a complementary metal-oxide-semiconductor (CMOS) with an infrared filter.

Moreover, the minimum numbers of the at least one transmitter 10 and the plural receivers 11 used in the detecting device 1 of the present invention may be determined according to precision requirement of the detecting device 1. For example, for performing the simplest detection to enable or disable an electrical appliance, the detecting device 1 may at least comprise one transmitter 10 and one receiver 11. Consequently, when the incident light beams 107 from the transmitter 10 strike the detection zone 5, the plural reflected light beams 108 reflected from the transmitter 5 are continuously received by the receiver 11. On the other hand, if the plural reflected light beams 108 are not received by the receiver 11, an enabling signal or a disabling signal is generated. Alternatively, for detecting the linear motion of the object 9, the detecting device 1 may at least comprise one transmitter 10 and two receivers 11. At a first time spot, one of the two receivers 11 is irradiated by the reflected light beams 108 but the other one of the two receivers 11 is not irradiated by the reflected light beams 108. At a second time spot, both of the two receivers are irradiated or not irradiated by the reflected light beams 108. Then, by judging the reception configuration of the receivers, the microprocessor 13 issues a corresponding signal according to the judging result. In response to the signal, an electrical appliance electrically connected with the detecting device 1 is correspondingly enabled, disabled or shifted. Alternatively, for detecting the planar motion of the object 9, the detecting device 1 may at least comprise one transmitter 10 and four receivers 11. After a computation is performed, a moving direction and a displacement of the object 9 within the planar detection zone can be calculated.

Alternatively, in some other embodiments, the receiver 11 is an image receiver. By comparing the difference between a first image at a first time spot and a second image at a second time spot, the image receiver 11 can further calculate the moving direction of the object 9. In this situation, the detecting device 1 may at least only comprise one transmitter 10 and one image receiver.

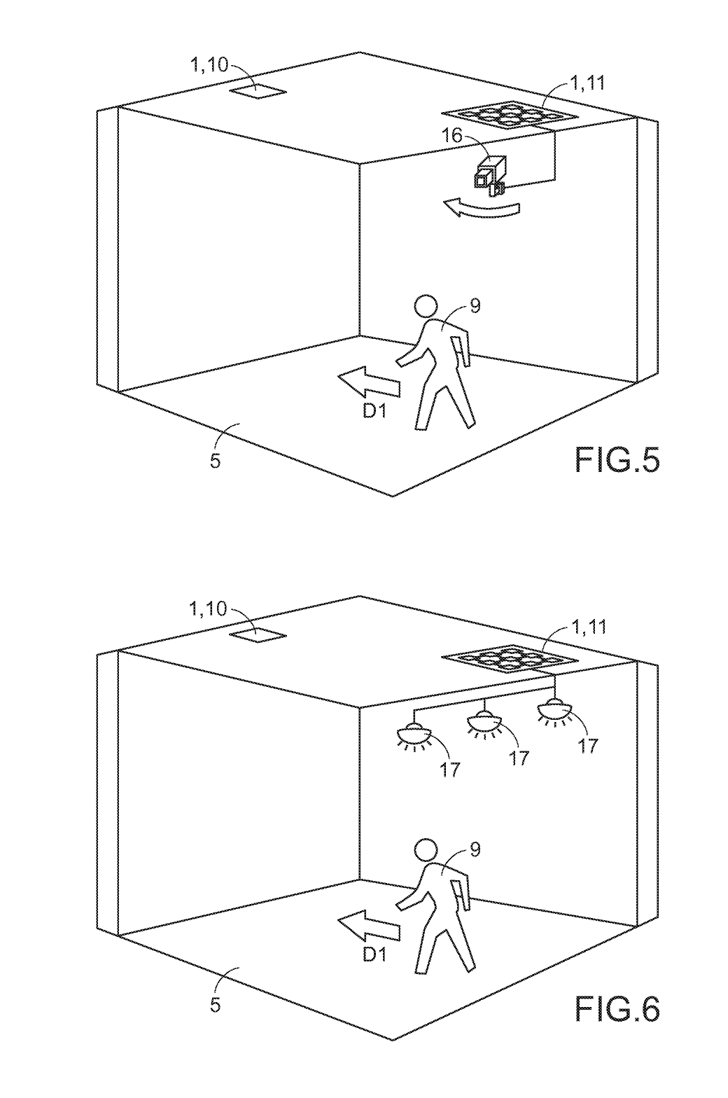

FIG. 5 schematically illustrates an implementation example of the detecting device according to the embodiment of the present invention, in which the detecting device further comprises an image pickup device. Please refer to FIGS. 1˜5. The detecting device 1 further comprises an image pickup device 16. The image pickup device 16 is electrically connected with the plural receivers 11. In case that the plural receivers 11 are in the disturbed reception configuration, the plural receivers 11 issue a signal to the image pickup device 16. In response to the signal, the image pickup device 16 is enabled. In this embodiment, the image pickup device 16 is capable of recording the image of the object 9 while tracking the object 9 in the moving direction D1. Furthermore, by analyzing and judging a distance between the object 9 and the image pickup device 16, the microprocessor 13 issues the signal to the image pickup device 16. Consequently, the image pickup device 16 can be precisely focused on the object 9 at any time. Under this circumstance, the recording performance is largely enhanced, and the recorded image is clearly identifiable.

FIG. 6 schematically illustrates an implementation example of the detecting device according to the embodiment of the present invention, in which the detecting device further comprises at least one lighting device. Please refer to FIGS. 1˜6. The at least one lighting device 17 is electrically connected with the plural receivers 11. In case that the plural receivers 11 are in the disturbed reception configuration, the plural receivers 11 issue a signal to the at least one lighting device 17. In response to the signal, the at least one lighting device 17 is enabled. Moreover, the microprocessor 13 is capable of judging the moving direction D1 of the object 9. In a preferred embodiment, plural lighting devices 17 are controlled to be sequentially turned on along the moving direction D1 of the object 9, and the plural lighting devices 17 are controlled to be sequentially turned off after the object 9 is moved away from the detection zone 5. Consequently, the convenient and power-saving purposes are achieved. An example of the lighting device 17 includes but is not limited to a light bulb, a light tube, a lamp or a work light. The lamp is for example a ceiling lamp or a garden lamp. The work light is for example a work light with a spraying function or a work light with a humidifying function. The examples of the lighting device 17 are presented herein for purpose of illustration and description only and are not intended to limit the scope of the present invention.

Alternatively, in some other embodiments, the detecting device 1 further comprises an alarm (not shown). The alarm is electrically connected with the plural receivers 11. In case that the plural receivers 11 are in the disturbed reception configuration, the plural receivers 11 issue a signal to the alarm. In response to the signal, the alarm is enabled. Moreover, any other electrical appliance to be automatically enabled may be electrically connected with the detecting device 1. The examples of the electrical appliances are presented herein for purpose of illustration and description only and are not intended to limit the scope of the present invention.

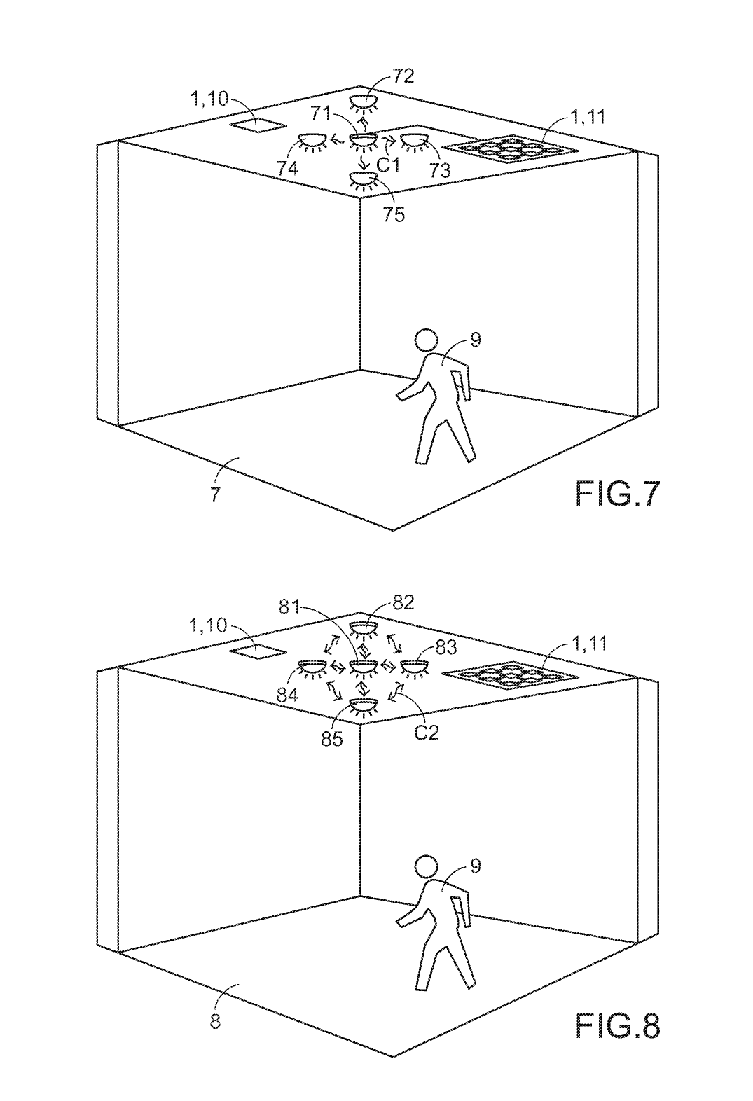

FIG. 7 schematically illustrates a first example of a group control mechanism of the detecting device according to the embodiment of the present invention. As shown in FIG. 7, five lighting devices 71˜75 are disposed within a detection zone 7. These lighting devices 71˜75 are in communication with each other through a communication channel. The communication channel is a wired communication channel or a wireless communication channel, but is not limited thereto. In this embodiment, the lighting device 71 is a lighting device including a light source (not shown) and an electromagnetic wireless communication module (not shown). Moreover, the lighting device 71 is a master control lighting device with an additional microprocessor (not shown). The additional microprocessor is electrically connected with the plural receivers 11 of the detecting device 1 through an electrical wire (not shown). An active detecting and scanning result between the transmitter 10 and the plural receivers 11 of the detecting device 1 may be inputted into and judged by the additional microprocessor.

Each of the lighting devices 72˜75 is a non-master control lighting device (e.g. an ordinary lighting device) with an electromagnetic wireless communication module (not shown). Moreover, each of the lighting devices 72˜75 has a controlled function. That is, each of the lighting devices 72˜75 can be passively controlled in response to a wireless lighting control, but each of the lighting devices 72˜75 cannot actively issue a control command. In this embodiment, according to the result of detecting the detection zone 7 by the detecting device 1, the lighting device 71 issues a control command C1 to the lighting devices 72˜75 with the controlled function.

FIG. 8 schematically illustrates a second example of a group control mechanism of the detecting device according to the embodiment of the present invention. As shown in FIG. 8, five lighting devices 81˜85 are disposed within a detection zone 8. Each of these lighting devices 81˜85 is a lighting device including a light source (not shown) and an electromagnetic wireless communication module (not shown). Moreover, each of these lighting devices 81˜85 has both of a master control function and a controlled function.

Moreover, each of the lighting devices 81˜85 includes an additional microprocessor (not shown). The additional microprocessor is in wireless communication with the plural receivers 11 of the detecting device 1. An active detecting and scanning result between the transmitter 10 and the plural receivers 11 of the detecting device 1 may be inputted into and judged by the additional microprocessor. Moreover, a lighting control program may be executed by the additional microprocessors of these lighting devices 81˜85 collaboratively.

By the above design, the lighting devices 81˜85 can be individually in wireless communication with the receivers 11. Moreover, in response to a wireless signal, the lighting devices 81˜85 are individually turned on or turned off. That is, according to the result of detecting the detection zone 7 by the detecting device 1, the lighting devices 81˜85 are individually turned on or turned off. Furthermore, the lighting devices 81˜85 may be in wireless communication with each other through electromagnetic waves in order to transmit a lighting control command C2 to or back the other lighting devices. Consequently, a more elaborate light tracking mechanism can be coordinated.

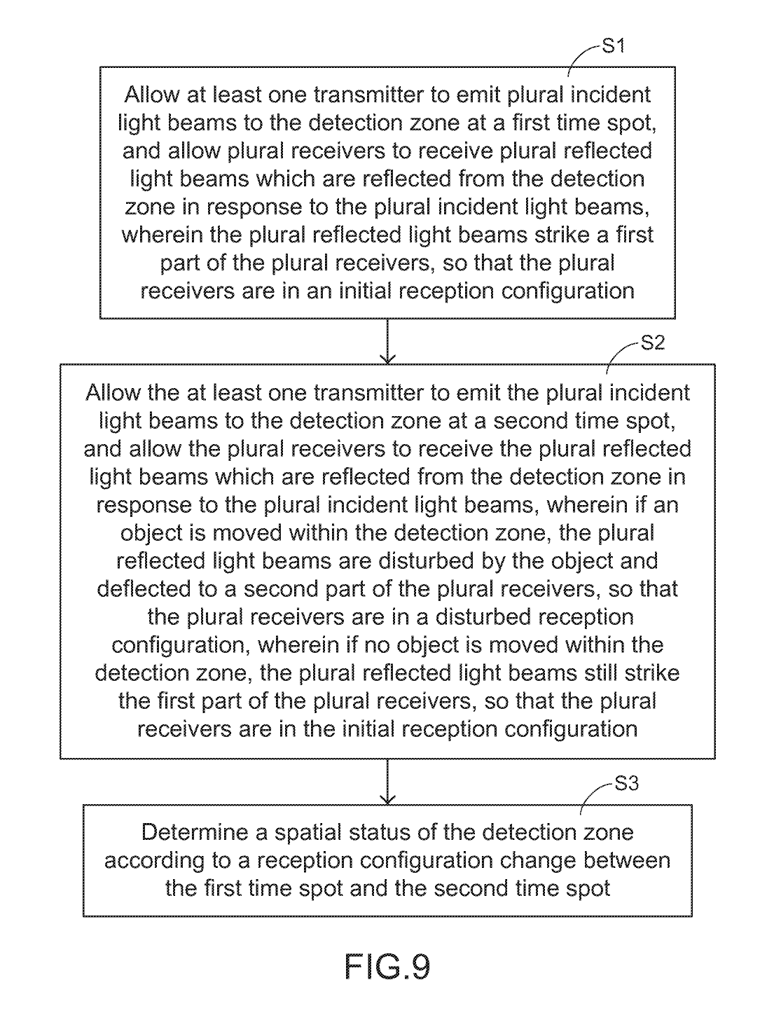

Hereinafter, the operating method of the detecting device of the present invention will be illustrated with reference to FIG. 9. FIG. 9 is a flowchart illustrating an operating method of the detecting device according to an embodiment of the present invention. Firstly, in the step S1, at least one transmitter 10 emits plural incident light beams 107 to a detection zone 5 at a first time spot, and plural reflected light beams 108 which are reflected from the detection zone 5 in response to the plural incident light beams 107 are received by plural receivers 11. Meanwhile, the plural reflected light beams 108 strike a first part 11a of the plural receivers 11, so that the plural receivers 11 are in an initial reception configuration. Then, in the step S2, the at least one transmitter 10 emits the plural incident light beams 107 to the detection zone 5 at a second time spot, and the plural reflected light beams 108 which are reflected from the detection zone 5 in response to the plural incident light beams 107 are received by plural receivers 11. If an object 9 is moved within the detection zone 5, the plural reflected light beams 108 are disturbed by the object 9 and deflected to a second part of the plural receivers 11, so that the plural receivers 11 are in a disturbed reception configuration. If no object is moved within the detection zone 5, the plural reflected light beams 108 still strike the first part 11a of the plural receivers 11, so that the plural receivers 11 are in the initial reception configuration. Then, in the step S3, a spatial status of the detection zone 5 is determined according to a reception configuration change between the first time spot and the second time spot. If the plural receivers 11 are still in the initial reception configuration at the second time spot (in the step S3), it is determined that no object is moved within the detection zone 5. Whereas, if the plural receivers 11 is changed from the initial reception configuration to the disturbed reception configuration, it is determined that the object 9 is moved within the detection zone 5.

From the above descriptions, the present invention provides a detecting device with at least one transmitter and plural receivers. After the at least one transmitter emits plural incident light beams to a detection zone, plural reflected light beams reflected from the detection zone are received by the plural receivers. Moreover, if the spatial status of the detection zone is changed, the reflected light beams are received by the plural receivers in various reception configurations. In other words, the current one dimensional detecting mechanism is improved as the three dimensional detecting mechanism of the present invention. Consequently, the detectable range is largely increased. Moreover, since the total number of the at least one transmitter and the plural receivers is reduced, the detecting device of the present invention is reduced. Moreover, after the reception configuration of the receivers is received by the microprocessor, the moving direction and the displacement of the object can be realized. Consequently, the ambient electrical appliance of the detecting device can perform a corresponding action by tracking the movement of the object.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A detecting device for detecting a detection zone, said detecting device comprising:
at least one transmitter for emitting plural incident light beams to said detection zone; and
plural receivers for receiving plural reflected light beams which are reflected from said detection zone in response to said plural incident light beams,
wherein when said at least one transmitter emits said plural incident light beams to said detection zone at a first time spot, said plural reflected light beams strike a first part of said plural receivers, so that said plural receivers are in an initial reception configuration, wherein when said at least one transmitter emits said plural incident light beams to said detection zone at a second time spot, if an object is moved within said detection zone, said plural reflected light beams strike a second part of said plural receivers in response to a position change of said object, so that said plural receivers are in a disturbed reception configuration, wherein according to said disturbed reception configuration, said detecting device judges that said object is moved within said detection zone.

2. The detecting device according to claim 1, further comprising a microprocessor, which is electrically connected with said plural receivers, wherein a moving direction of said object is calculated by said microprocessor according to projecting areas and/or angles of said reflected light beams relative to said first part and said second part of said plural receivers.

3. The detecting device according to claim 2, wherein said transmitter is an active infrared transmitter.

4. The detecting device according to claim 3, wherein each of said plural receivers is selected from an active infrared receiver, a charge coupled device with an infrared filter or a complementary metal-oxide-semiconductor with an infrared filter.

5. The detecting device according to claim 4, further comprising an image pickup device, which is electrically connected with said plural receivers, wherein when said plural receivers are in said disturbed reception configuration, said plural receivers issue a signal to said image pickup device, thereby enabling said image pickup device.

6. The detecting device according to claim 5, wherein said image pickup device is moved along said moving direction of said object for recording an image of said object, wherein by analyzing and judging a distance between said object and said image pickup device, said microprocessor allows said image pickup device to be focused on said object.

7. The detecting device according to claim 1, further comprising at least one lighting device, which is electrically connected with said plural receivers, wherein when said plural receivers are in said disturbed reception configuration, said plural receivers issue a signal to said at least one lighting device, thereby enabling said at least one lighting device.

8. The detecting device according to claim 7, wherein said lighting device is a light bulb, a light tube, a lamp or a work light, wherein said lamp is a ceiling lamp or a garden lamp, and said work light is a work light with a spraying function or a work light with a humidifying function.

9. The detecting device according to claim 1, further comprising a lighting group, wherein said lighting group comprises at least one first lighting device and a second lighting device, and said at least one first lighting device and said second lighting device are in communication with each other through a communication channel.

10. The detecting device according to claim 9, wherein said first lighting device is a master control lighting device, and said second lighting device has a controlled function, wherein according to a result of detecting said detection zone, said first lighting device is actively controlled to be turned on or turned off, and said second lighting device is passively controlled to be turned on or turned off in response to a control command from said first lighting device.

11. The detecting device according to claim 10, wherein each of said first lighting device and said second lighting device has both of a master control function and a controlled function, wherein when a lighting control program is executed, said first lighting device and said second lighting device are controlled to be turned on or turned off.

12. The detecting device according to claim 1, further comprising an alarm, which is electrically connected with said plural receivers, wherein when said plural receivers are in said disturbed reception configuration, said plural receivers issue a signal to said alarm, thereby enabling said alarm.

13. The detecting device according to claim 1, wherein said plural receivers are distributed in an array arrangement or a linear arrangement.

14. An operating method of a detecting device, said operating method comprising steps of:
(a) allowing at least one transmitter to emit plural incident light beams to said detection zone at a first time spot, and allowing plural receivers to receive plural reflected light beams which are reflected from said detection zone in response to said plural incident light beams, wherein said plural reflected light beams strike a first part of said plural receivers, so that said plural receivers are in an initial reception configuration;
(b) allowing said at least one transmitter to emit said plural incident light beams to said detection zone at a second time spot, and allowing said plural receivers to receive said plural reflected light beams which are reflected from said detection zone in response to said plural incident light beams, wherein if an object is moved within said detection zone, said plural reflected light beams are disturbed by said object and deflected to a second part of said plural receivers, so that said plural receivers are in a disturbed reception configuration, wherein if no object is moved within said detection zone, said plural reflected light beams still strike said first part of said plural receivers, so that said plural receivers are in said initial reception configuration; and
(c) determining a spatial status of said detection zone according to a reception configuration change between said first time spot and said second time spot.

15. The operating method according to claim 14, wherein said detecting device further comprises a microprocessor, which is electrically connected with said plural receivers, wherein a moving direction is calculated by said microprocessor according to projecting areas and/or angles of said reflected light beams relative to said first part and said second part of said plural receivers.

16. The operating method according to claim 15, wherein said transmitter is an active infrared transmitter.

17. The operating method according to claim 16, wherein each of said plural receivers is selected from an active infrared receiver, a charge coupled device with an infrared filter or a complementary metal-oxide-semiconductor with an infrared filter.
